(19) United States
(12) Patent Application Publication
(10) Pub. No.: US 2009/0191443 A1
(43) Pub. Date: Jul. 30, 2009

(54) PLANAR FUEL CELL

(76) Inventor: Panjak Sinha, (US)

Correspondence Address: GARY F. WITTING, 5834 EAST OAK STREET, SCOTTSDALE, AZ, 85257, US

(21) Appl. No.: 12/020,629

(22) Filed: Jan. 28, 2008

(51) Int. Cl. H01M 8/00

(52) U.S. Cl. 429/34; 29/623.1

(57) ABSTRACT

A planar fuel cell (101) having a channel (108) with a length (224), a width (126), a depth (228) is disposed into the substrate (102). The channel (108) has a first end portion (111), a second end portion (112), and a middle portion (114) with the middle portion (114) separating the first end portion (111) and the second end portion (112) by a certain length (224). A first catalytic region (116) is disposed onto at least a portion of the first end portion (114) and the second catalytic region (116) is disposed on at least a portion of the second end potion (112) of the channel (108) with the first catalytic region (116) and the second catalytic region (118) separated by a certain length (224).

### FIELD OF INVENTION

The present invention generally relates to fuel cells; and more particularly, to membraneless monolithic fuel cells and methods of making, design, and integrating, these membraneless fuel cells into systems.

### BACKGROUND

Global needs for electrical power outside of the electrical distribution grids has dramatically increased and will increase even more for the foreseeable future. Nearly two billion people around the globe are living outside an electrical grid. Wireless portable devices often require electrical power outside of the electrical distribution grids. Power outages due to natural disasters severely disrupt our lives, which are dependant on uninterrupted electrical power from the electrical distribution grids, forcing use of electrical power outside of the electrical distribution grids. Thus, having electrical power that can be inexpensively and easily generated outside the electrical distribution grid is important and necessary for today's electrical power requirements including both portable devices and fixed electrical power needs.

More particularly, access to electrical power in areas not covered by electrical power grids is becoming more important as wireless devices are becoming ubiquitous and often not in close proximity to electrical grids. Moreover, in rural areas of developing countries, where the electricity is limited or where electrical grids network is limited, an alternate source of simple and inexpensive electricity is becoming very important.

Additionally, high energy-density electrical sources are becoming more important as energy demands continue to increase throughout the world. This is especially true with our increasing reliance on portable devices. Generally, battery technologies have been primarily used to support portable devices. However, energy densities of battery technology are not keeping up with the energy demands and requirements of portable devices. Batteries require frequent replacement and have a significant environmental impact. Thus, an alternate energy technology with significantly higher energy density is needed to support the energy requirements of today and into the future.

Fuel cells have been known for quite some time. The fuel cell was discovered by William Robert Grove (1811-1896), a Welsh lawyer turned scientist in 1938. Because of the potential advantages of fuel cells such as a clean and reliable energy source, use of multiple and different fuel types, efficient conversion of fuel to energy, and use of high power density fuels has recently increased interest in fuel cells. Since 1938, many individuals and large businesses have made a variety of contributions to the technology and have spent hundreds of millions of dollars in fuel cell research with varied successes.

However, conventional micro fuel cell technology still has many problems which prevent fuel cells from being widely accepted into the market place. Conventional fuel cells typically are made of materials that are assembled together to form a substantially large assembly, whose size can range in meters, that is held together by screws, bolts, and the like. Because of the size and the inflexibility of the materials, use of conventional fuel cell technology is cumbersome and inadequate for today's small foot print requirements.

Generally, micro fuel cells have been based on several conventional technologies such as Proton Exchange Membrane (PEM), Phosphoric Acid Fuel Cell (PAFC), Solid Oxide Fuel Cells (SOFC), and the like technologies. However, each of these technologies has one or more problems preventing large scale market adoption. For instance, use of PEM that separates the cathode and anode, and the fuel from the oxidizer, respectively, adds substantial complexity and cost to all aspects of the manufacturing and use of fuel cells and micro-fuel cells. The PEM material typically is made, cut, and applied mechanically to a fixture that allows the separation of the fuel and oxidizer. Because of PEM's physical nature, physical limitations, excessive costs, and other limitations, use of PEM is not well suited for large-scale low cost mass production manufacturing or miniaturization. Additionally, because of the difficulties such as cost, inflexibility of PEM technology, large form requirements, fuel cells requiring PEM technology have serious problems being compatible with portable devices and gaining acceptance into the marketplace.

Additionally, another problem with conventional PEM fuel cells is the thickness of the PEM material itself. Thin (several microns) and delicate nature of the PEM material, the mechanical handling and assembly using PEM is difficult and complicated which increases cost considerably. In addition, fuel cross over is a known problem with PEM, which reduces the cathode efficiency. Because these problems and others, conventional fuel cells suffer from poor efficiencies that affect the overall power output and the efficiencies of generating power, thereby seriously effecting the adoption of fuel cells into the market place.

Another problem with conventional fuel cell technology is that with normal use of a carbon containing fuel, e.g. methanol, the fuel cell byproducts, carbon monoxide, of the chemical reaction that occurs in the fuel cell degrade the platinum catalyst, thereby limiting the life time of the fuel cell and further causing reliability problems. Moreover, since the catalyst (platinum) is extremely expensive, rebuilding, refurbishing, and/or replacement is unattractive, if not impossible because of cost.

It can be readily seen that conventional fuel cells still have several problems and disadvantages. Despite many advantages of fuel cells, market acceptance is limited, especially in portable applications. Further, since some of the applications of fuel cells are high volume applications, theses problems and disadvantages do not allow fuel cell technology to be used so as to drive the cost of fuel cells lower and to be more useful in high volume applications. Therefore, a low cost fuel cell with high volume manufacturability and better efficiency would be highly desirable.

### SUMMARY OF THE INVENTION

In various representative aspects, the present invention provides a monolithic fuel cell in which inter alia a substrate that is substantially planar is used. A planar fuel cell having a channel with a length, a width, a depth is disposed into the substrate. The channel has a first end portion, a second end portion, and a middle portion with the middle portion separating the first end portion and the second end portion by a certain distance. A first catalytic portion is disposed onto at least a portion of the first end portion and the second catalytic portion is disposed on at least a portion of the second end portion of the channel with the first catalytic portion and the second catalytic portion separated by a certain distance.

The substrate can be made of any suitable material such as a conductive material, a semiconductive material, or a dielectric material. In the case of conductive and semiconductive materials, an insulative layer is typically disposed between the substrate and the first and second end portion and the middle portion of the channel. It should be understood that the insulating material is compatible or made compatible with the materials and chemicals used for the monolithic fuel cell.

An exemplary method for fabricating such a device is disclosed as comprising the steps, inter alia, providing a substantially planar substrate. Forming a channel into the substrate having a length, a width, and a depth, wherein the channel has a first end portion, a middle portion, and a second end portion and wherein the first end portion and the second end portion is coupled by the middle portion of the channel. Forming a first catalytic portion and a second catalytic portion on at least a portion of the first end portion and the second end portion of the channel, respectively.

The substrate can be made of any suitable material such as a conductive material, a semiconductive material, or a dielectric material, with the channel being made by any suitable process such as, but not limited to, molding, stamping, milling, a combination of process, such as photolithographic, lift-off processing, and etching processes.

In another monolithic fuel cell in which inter alia a substrate that is substantially planar is used having a first surface and a second surface. A first opening, a second opening, and a third opening are disposed into the first surface of the substrate. A cavity extending under at least a portion of the first opening, a portion of the second opening, and a portion of the third opening, wherein the cavity communicates with the first opening, the second opening, and the third opening. A first catalytic region disposed onto at least a portion of the first opening and onto at least a first portion of the first surface. A second catalytic region disposed onto at least portion of the third opening and onto at least a second portion of the first surface and of the substrate.

An exemplary method for fabricating such a device is disclosed as comprising the steps, inter alia, of providing a substantially planar substrate having a first surface and a second surface. Forming a first opening, a second opening, and a third opening. Forming a cavity extending under a portion of at least the first opening, the second opening, and the third opening, wherein the cavity communicates to the first opening, the second opening, and the third opening. Disposing a first catalyst portion onto at least a portion of the first opening and onto at least a first portion of the first surface of the substrate. Disposing a second catalyst onto at least a portion of the second opening and onto at least a second portion of the surface of the substrate.

Formation of the first opening, second opening, and third opening can be made by any suitable process such as, but not limited to, masking such as photolithographic masking, etching, milling, or the like.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWING

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 shows a greatly enlarge simplified isometric illustration of a plurality of planar fuel cells;

FIG. 2 shows a greatly enlarged simplified isometric sectional illustration of the plurality of planar fuel cells of FIG. 1 taken though 2-2 of FIG. 1;

FIG. 3 shows a greatly enlarged simplified isometric sectional illustration of FIG. 2 with electrolyte solution and fuel solutions are present in some of the plurality of fuel cells;

FIG. 4 shows a greatly enlarged simplified isometric sectional illustration of a substrate having surfaces wherein one surface of the substrate is masked during fabrication of a plurality of fuel cells;

FIG. 5 shows a greatly enlarged simplified isometric sectional illustration of the first masking step after the first surface of the substrate has been etched during fabrication of the plurality of fuel cells;

FIG. 6 shows a greatly enlarged simplified isometric sectional illustration of a second masking step on the second surface of the substrate prior to etching of the second surface during fabrication of the plurality of fuel cells;

FIG. 7 shows a greatly enlarged simplified isometric sectional illustration of the substrate after the second surface has been etched during fabrication of the plurality of fuel cells;

FIG. 8 shows a greatly enlarged simplified isometric sectional illustration of the substrate after the substrate has been etched and cleaned during fabrication of the plurality of fuel cells;

FIG. 9 shows a greatly enlarge simplified isometric sectional illustration showing a third masking step covering the second opening in preparation of a deposition step during fabrication of the plurality of fuel cells;

FIG. 10 shows a greatly enlarged simplified isometric sectional illustration of a deposition step of a catalytic material on the third masking step during fabrication of the plurality of fuel cells;

FIG. 11 shows a greatly enlarged simplified isometric sectional illustration of substrate with catalytic material disposed on substrate during fabrication of the plurality of fuel cells;

FIG. 12 shows a greatly enlarged simplified isometric sectional illustration of a plurality of fuel cells having fuel and electrolyte solutions in place in substrate; and

FIG. 13 is a greatly enlarged topographic plan illustration of a fuel cell power system suitable for use with planar fuel cell(s), a plurality of monolithic fuels cells, and the like disposed on a substrate.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms front, back, top, bottom, over, under, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF EXEMPLARY EMBODIMENTS

Before addressing details of embodiments described below, some terms are defined or clarified.

The term “catalyst” is intended to mean any material that is capable of lowering the activation energy of a reaction so as to complete the reaction with lower energy. The catalyst material can include, but is not limited, transition metals, noble metals, perovskites, or the like.

The term “catalytic region” is intended to mean an area or region where a catalyst is formed to catalyze a reaction. The catalytic region may contain or be combined with an electrode layer under or in the catalyst so as to facilitate electrical coupling.

The term “anode” is intended to mean a potentially electrically active region or area where a chemical oxidation reaction of a fuel can take place.

The term “cathode” is intended to mean a potentially electrically active region or area where a chemical reduction reaction of an oxidant can take place.

The term “monolithic” is intended to mean a self contained single object as in one body or piece. By way of example only, a fuel cell is made by manipulating the substrate, adding and subtracting layers, in part or in whole, in order to build a mechanically and electrically active fuel cell device that is monolithic. However, it should be understood that other devices, accessories, and the like can be added to the fuel cell so as to enhance the functionality of the fuel cell.

The term “strapping” is intended to mean electrically coupling one device to another device and/or a plurality of wherein the devices are either electrically active or electrically passive. For example, electrically coupling one device to either an electrically active device to another electrically active device; or electrically coupling an electrically active device to an electrically passive device. For example, a fuel cell could be electrically coupled to one or more other fuel cells, either in series or in parallel, to obtain desired voltage and/or current levels. In yet another example, a fuel cell can be coupled to any electrically active or passive devices such as, but not limited to, an inductive device, capacitive device, transistor containing device, or the like.

The term “bipolar plate” is intended to mean an electrically conductive piece of metal that electrically couples one or more surfaces of an anode to one or more surfaces of an adjacent cathode. For example, when a plurality of anode is strapped to a plurality of cathodes.

The term “handle” is intended to mean any suitable means or device for providing support to facilitate handling of the substrate during processing.

The term “electrolyte solution” is intended to mean aqueous solution of electrolyte in water such that electrolyte is dissociated into its ions.

The term “fuel solution” is intended to mean a fuel in fluid phase—either pure or dissolved in a solvent. For example methanol may be pure or dissolved in water. Where gaseous fuel is used, fuel solution may be pure gaseous fuel or may be dissolved in a liquid. For example, pure hydrogen or dissolved in an acid such as sulfuric acid, phosphoric or the like.

The term “fuel” is intended to mean any fluid that is an oxidizable substance that will yield hydrogen ions and electrons such as, but not limited to, oxygenated hydrocarbons (e.g. only, alcohols, sugars, or the like), hydrogen (gas), or the like. Also, fuel can be an elemental gas, such as hydrogen or in solution such as sugar in an aqueous solution. In case of hydrogen fuel, hydrogen gas diffuses through the electrolyte solution to the catalyst surface to react.

The term “oxidant” is intended to mean any fluid that is a reduction capable substance such as, but not limited to, oxygen, oxygen bearing substance, such as hydrogen peroxide, or the like.

The term “cavity” is intended to mean any hollowed out structure that is designed and made to provide a capillary force to hold a fuel, an oxidant (if used), and an electrolyte.

The term “electrolyte” is intended to mean a fluid that is ionized and is capable of conducting positive or negative ions but does not conduct electrons.

The term “substrate” is intended to mean a base material and all layer(s) member(s), and structures(s) present over the base material at a particular point in a process. The base material can include a single material, a composite of materials, stacked materials, of the same or different materials. For example, before any processing occurs the substrate and base material may be the same. However, before forming a catalytic region the substrate may include a dielectric material.

The term “opening” is intended to mean an area in a layer or in a substrate that is devoid of material generating a window or opening in a substrate or layer. Opening can be any suitable shape.

The term “deposition” is intended to mean disposing a first material onto a second material by any suitable method or technique such as, but not limited to, evaporation, sputtering, chemical vapor deposition, plasma enhanced chemical deposition, plating, or the like.

The term “evaporating” is intended to mean converting a material from a liquid or a solid phase to a vapor phase.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

Further, unless expressly stated to the contrary, “or” refers to an inclusive or and not to an exclusive or. For example, a condition A or B is satisfied by any one of the following: A is true (or present) and B is false (or not present), A is false (or not present and B is true (or present, and both A and B are true (or present) Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the fuel cell and chemical arts.

The following descriptions are of exemplary embodiments of the invention and the inventors' conceptions of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a device, a method of making a monolithic fuel cell that is suitably adapted for scaling up, flexible in mechanical and electrical design, and can be strapped with other devices, is presented as a specific enabling disclosure that may be readily generalized by skilled artisans to any application of the disclosed monolithic fuel cell in accordance with various embodiments of the present invention.

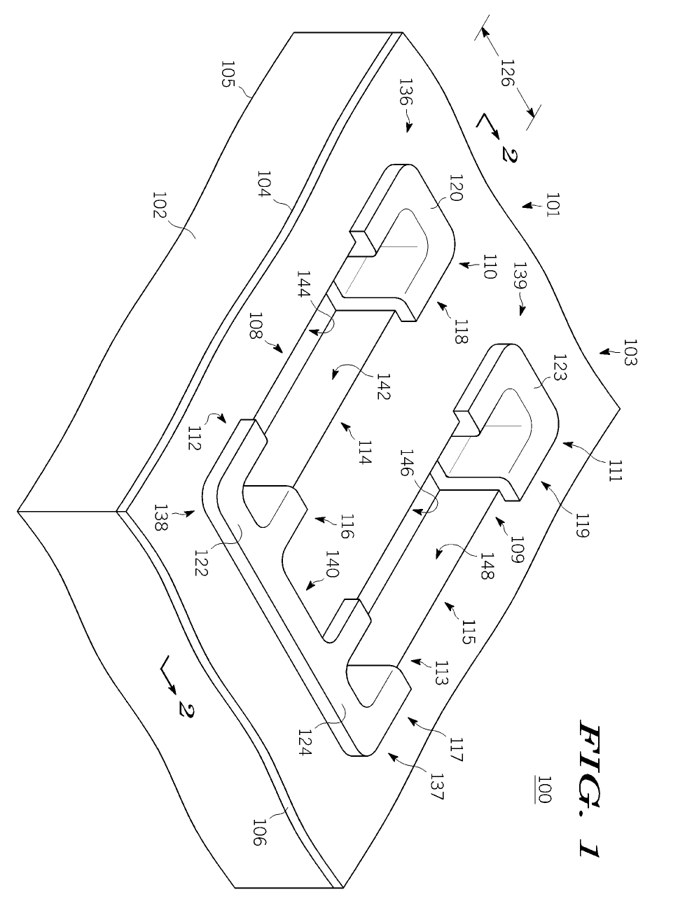

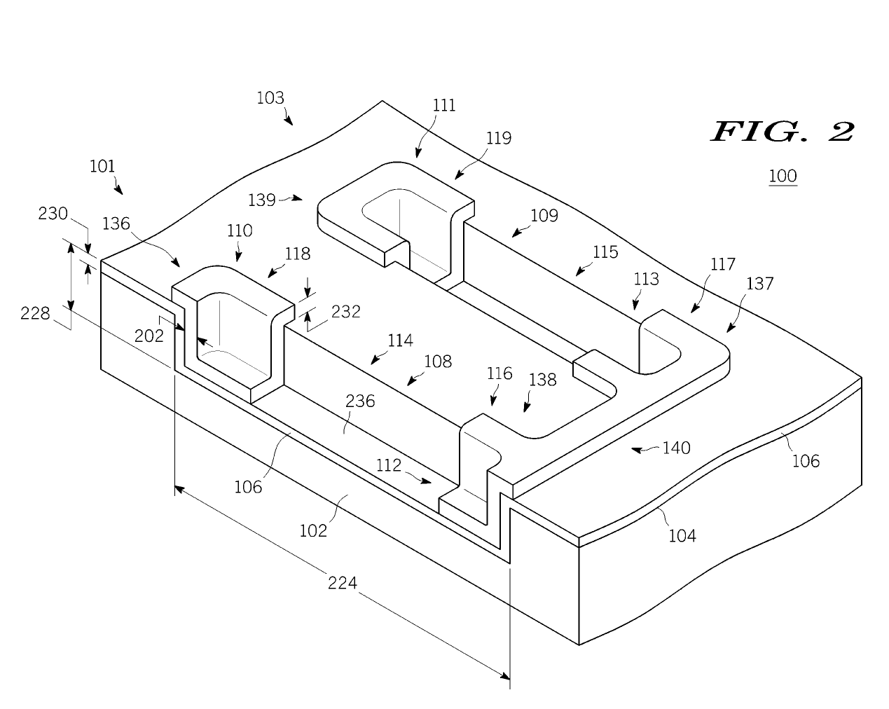

Referring now to FIGS. 1 and 2, FIG. 1 shows a greatly enlarge simplified isometric sectional illustration of a plurality of planar fuel cells 100. The plurality of fuel cells 100 is illustrated by planar fuel cells 101 and 103. Planar fuel cell 101 includes a channel 108 having sides 142 and 144, bottom 236 (shown in FIG. 2) an anode 136, a cathode 138, catalytic regions 116 and 118 fabricated into substrate 102 having surfaces 104 and 105 with a material layer 106, and planar fuel cell 103 includes a channel 109 having sides 146 and 148, an anode 137, a cathode 139, catalytic regions 117 and 119 fabricated into substrate 102 having a surface 104 with a material layer 106 disposed thereon. It should be understood that material layer 106 may or may not be used depending upon the materials and processes used for fabricating the plurality of planar fuel cells 100. FIG. 2 shows a greatly enlarged simplified isometric sectional illustration of the plurality of planar fuel cells 100 of FIG. 1 with a section taken though 2-2 of channel 108. As can be seen in FIGS. 1 and 2, the plurality of planar fuel cells 100 includes substrate 102 with channels 108 and 109 formed into the substrate 102. Channels 108 and 109 include end portions 110 and 112 and end portions 111 and 113, and with middle portions 114 and 115, respectively. However, it should be noted and understood that while end portions 110, 112 and 111, and 113 as shown in FIGS. 1-3 are physically terminated by end portions 110, 111, 112, and 113, as well as by other associated structures such as catalytic regions 116, 118, 117, and 119, chemically end portions can be formed by the termination of electrolyte and fuel solutions 302 and 304. For example, with fuel solution 302 and electrolyte solution 304 only partially filling channel 108, channel 108 would not need to be completely filled for fuel cell 101 to generate electricity. Generally, this is due to surface tension and meniscus formation fuel solution 302 and electrolyte 304. Anodes 136 and 137 cathodes 138 and 139 have catalytic regions 118 and 119, and 116 and 117, respectively, and are formed on at least a portion of end portions 110 and 111, and end portions 111 and 113, respectively, of channels 108 and 109. Additionally, as illustrated in FIGS. 1 and 2, contact pads 120 and 122, and contact pads 123 and 124 can be extended from catalytic regions 116 and 118, and 119 and 117 out along surface 104 of substrate 102 so as to allow electrical connection to fuel cells 108 and 109, either signally or together. Load 306 is connected between anode 136 and cathode 139 of planar fuel cells 101 and 103, thereby allowing electricity developed from fuel cells 101 and 103 to use measured, used, stored, and the like. It should be understood by one of ordinary skill in the art that load 306 can represent any suitable electrical device.

Further as shown in FIGS. 1-3, fuel cells 108 and 109 are electrically connected by an extension member 140 which extends from cathode 138 to cathode 139, in this particular case. However, it should be understood that other configurations are possible so that the plurality of fuel cells 100 can be connected in series or in parallel, thereby allowing any desired current and/or voltage to be selected or designed. Further, though the use of other extensions electrical coupling can be achieved to other portions of substrate 102, as well as other devices either mounted to substrate 102 or connected thereto. It should be understood that while FIGS. 1-3 only shows a small portion of substrate 102, substrate 102 can extend from side to side and from into and out of the Figures.

Substrate 102 can be made of any suitable material such as, but not limited to, a metal material, a semiconductor material, or a dielectric material. In the case of substrate 102 being made of a metal material, any suitable metal material can be used such as, but not limited to, ferrous materials and their derivatives, aluminum materials and their derivatives, copper materials and their derivatives, and any combination thereof, or the like. In the case of substrate 102 being made of a semiconductor material, any suitable semiconductor material can be used such as, but not limited to, silicon material, germanium material, Safire material, or the like. In the case of substrate 102 being made of a dielectric material, any suitable dielectric material can be used such as, but not limited to, a ceramic material, an oxide material or its derivatives, a nitride material or its derivatives, and polymer material or its derivatives. While any suitable material can be used for substrate 102, it should be understood that selection of materials for substrate 102 determines, in part, the methods, techniques, and other materials that can be used in the processing of substrate 102.

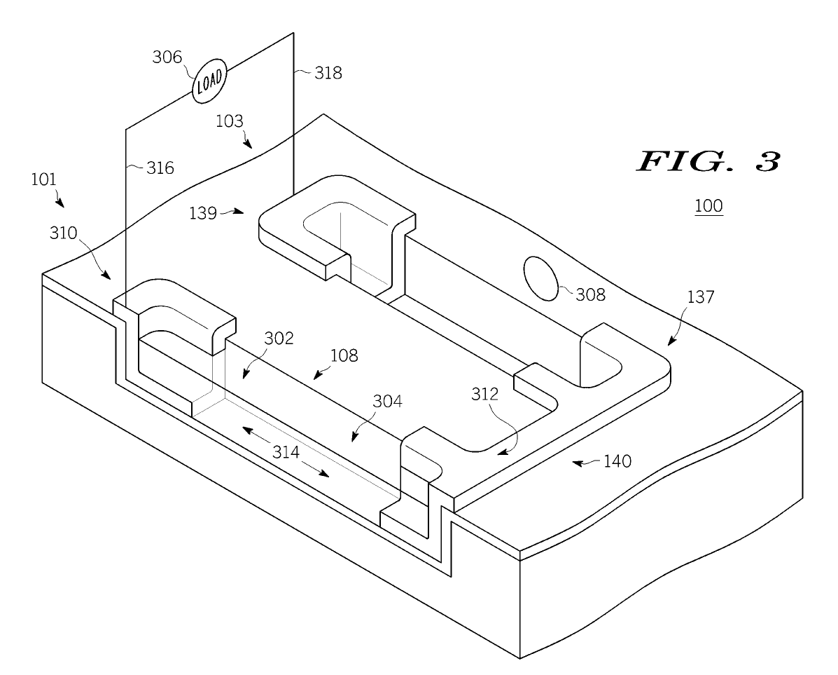

Since planar fuel cell 101 utilizes an electrolyte solution 304 (as shown in FIG. 3) in order to make electrical energy, having electrolyte solution 304 being in contact with electrically conductive materials, i.e., a metal material or a semiconductive material, is not compatible because the electrical energy formed between anode 136 and cathode 138 would electrically short together and fuel cell would not work. Thus, a material layer 106 that is a dielectric material can be interposed between the conductive and/or semiconductive substrate 102 and electrolyte solution 304 and fuel solution 302.

However, in some cases, use of a metal material and/or a semiconductor material has certain advantages such as, but not limited to, electrical advantages, processing advantages, and the like. For instance, use of a metal material lends itself to metal manipulation by processes such as, but not limited to, photolithography, etching, milling, stamping, micromachining, physical and chemical cleaning and the like, thereby allowing effective manipulation of substrate 102. Use of semiconductor materials lends itself to manipulation by processes such as, but not limited to photolithography, etching, physical and chemical cleaning, surface treatments, micromachining, milling, ion milling, and the like. Use of dielectric materials lends itself, manipulation by processes such as, but not limited to, molding, micromachining, photolithography, etching, chemical cleaning, surface treatments, and the like. With such a variety of processes and substrate materials available, selection of substrate 102 is carefully selected with the specific application and materials in mind.

Using channel 108 to describe the making of both channels 108 and 109. Channel 108 can be made by any suitable method or technique or combinations of methods or techniques depending upon the substrate materials used. By way of example only, with substrate 102 being made of a metal material, channel 108 can be made by any suitable processing technique or method such as, but not limited to, photolithography, etching, stamping, or the like. With substrate 102 being made of semiconductor material, channel 108 is made by any suitable processing technique or method such as, but not limited to, photolithography, etching, or the like. With substrate 102 being made of a polymer material such as plastic, such as, but not limited to, Teflon, polycarbonate family, polyvinyl family, polyester family, the polystyrene family, or the like, channel 108 is made by any suitable processing technique or method such as, but not limited to, photolithography, etching, or the like. More specifically, with substrate made of silicon, channel 108 and goes though a photolithographic and etch process.

Generally, photolythography is a process in which a substrate is coated with a photosensitive masking material called photoresist or a photoresist like material. An aerial image is then projected onto the photosensitive masking material exposing the photoresist to areas of light and dark. The exposed aerial image in the photoresist that is coating the substrate is subsequently developed by a development process, thereby producing a pattern in the photoresist of areas that are covered by photoresist and areas where the photoresist has been washed away, thereby exposing areas of the underlying substrate. Depending upon the type of photoresist (positive or negative) a pattern is generated corresponding to the Ariel image. With positive photoresist, the areas that are exposed to light are not washed away during the development process, while the areas that are not exposed to light are washed away by the development process, thereby exposing the underlying substrate. With negative photo resist, the areas that are exposed to light are washed away exposing the underlying substrate after the development process, while the areas that are not exposed to light are not washed away by the development process leaving the negative photoresist protecting the underlying substrate in some areas and exposing the underlying substrate in other areas.

Generally, photoresist can be any suitable thickness and is application specific. Typically, photoresist can range between 2,000-25,000 Angstroms, with a median range from 5,000-15,000 Angstroms, and fine range from 7,000-13,000 Angstroms. However, it should be understood that additional thickness of photoresist can be achieved with additional exposure time. Additionally, it should be understood that other masking films have been developed that allow for thick film processing.

By way of example only, with substrate 102 being made of silicon and with positive photoresist materials being used, an aerial image (not shown) of channel 108 is generated and exposes the photoresist covering substrate 102. The shape of channel 108 is not illuminated, i.e., shaded, and that shaded image is projected onto the photoresist, thereby not exposing the photoresist, while the remaining photoresist material on substrate 102 is exposed. The photoresist material is subsequently developed and the unexposed portions are washed away, while the exposed portions are retained on surface 104. This results with the shape of channel 108 being developed which exposes underlying substrate 102. It should understood that using a negative photoresist material, the result is the inverse, i.e., when negative photoresist is exposed to light, the exposed negative photoresist is washed away when developed.

Generally, the photolithography process described supra allows for making patterns in a photosensitive masking material having small dimensions and tolerances which are subsequently transferred into substrate 102 by an etch process (discussed below). The patterns can also be generated and transferred by any suitable alternate methods or techniques such as laser ablation or the like.

As shown in FIGS. 1, 2, and 3, channel 108 has several dimensional aspects such as, but not limited to, a length 224, a width 126, and a depth 228. It should be understood that the processes described supra are designed to transfer correct dimensional constraints to the photoresist layer which in turn are transferred to substrate 102. For example, channel 108 can be made to any suitable length 224 such as, but not limited to sub microns to several centimeters. It should also be understood that channel 108 can be formed into any desirable shape or geometric pattern such as, but not limited to, a serpentine pattern, a straight pattern, a random pattern, or the like.

Generally, channel 108 is designed to take advantage of capillary action in order to hold fluids in place. The desired capillary action is derived from a relationship between width 126 between sides 142 and 144 and depth 228. Generally, capillary action is governed by the following formula:

$$h = \frac{2 γ cos θ}{ρ gr}$$

where γ is the liquid-air surface tension (J/m² or N/m)
where θ is the contact angle
where ρ is the density of liquid (kg/m³)
where g is acceleration due to gravity (m/s²)
where r is radius of tube (m)

For a water filled glass tube in air and at sea level:
where γ is 0.0728 J/m² at 20° C.
where θ is 20° (0.35 rad)
where ρ is 1000 kg/m³
where g is 9.8 m/s²

Substitution of the values presented above results in the following equation:

$$h = \frac{1.4 \times {10}^{- 5}}{r}$$

Thus, by way of example only, for a 2 meter wide (a 1.0 meter radius) tube, the water would rise an unnoticable 0.014 millimeter. However, for a 2 centimeter wide tube, the water would rise 1.4 mm (or about 0.06 inch).

It should be understood that by using the same equation found in paragraph [69] but solving for r (half width) yields the following equation that allows for the calculation of a radius for a particular height of capillary action as demonstrated by the following equation:

$$r = \frac{1.4 \times {10}^{- 5}}{h} .$$

Calculation of r enables the determination of a minimum width 126 for any given depth 228 of channel 108.

By way of example only, with substrate 102 being made of 8″ silicon wafer and with depth 228 of channel 108 being 700 microns, the minimum width 126 can be calculated that will allow fluid including fuel solution 302 and electrolyte solution 304 held by capillary action in channel 108.

Using the equations used supra and assuming fuel solution 302 and electrolyte solution 304 bear properties of water with the following values:
where γ is 0.0728 J/m² at 20° C.
where θ is 20° (0.35 rad)
where ρ is 1000 kg/m³
where g is 9.8 m/s²

Results in the following equation:

$$r = \frac{1.4 \times {10}^{- 5}}{h} .$$

With h being equal to depth 228 and depth 228 being equal to 700 microns, the minimum width 126 can be 4.0 cm. Thus, any width 126 less then 4.0 cm can be used to hold fuel solution 302 and electrolyte solution 304 by the capillary action developed between sides 142 and 144. Further, with substrate 102 being an 8.0 inch silicon wafer having a thickness of 700 microns, this allows depth 228 of channel 108 to go all the way though substrate 102 from surface 104 to surface 105 and still hold fuel solution 302 and electrolyte solution 304 between sides 142 and 144 of channel 108. The actual dimensions must be optimized for the selected material and solutions.

Once width 126, depth 228, and length have been calculated, designed, and the appropriated image has been formed in the photoresist on substrate 102, substrate 102 is ready for etching and transferring the image in the photoresist to substrate 102.

Generally, the transfer of the image into substrate is achieved by etching which removes unwanted material from exposed areas in the photoresist mask. Etching chemistries and processes are numerous and generally are material and application specific. Thus, the specific nature and chemistries will not be discussed in detail here.

By way of example only, with substrate 102 being made of silicon, with photoresist mask having openings exposing surface 104 of substrate 102, and with the openings representative of channel 108 while other areas are covered by the photomask, surface 104 of substrate 102 is dry etched with a chlorine based chemistry, thereby removing the unwanted material and forming channel 108 as shown in FIGS. 1, 2, and 3. It should be understood that substrate 102 with photoresist mask having openings exposing portions of surface 104 of substrate 102 while other portions are covered and protected by the photoresist mask, substrate 102 is etched by any suitable method or technique such as but not limited to, dry etching or wet etching, to remove the exposed areas of surface 104 of substrate 102. Etching of these exposed areas of surface 104 transfers the shape of channel 108 into substrate 102. It should be understood that depending upon which substrate 102 material is used and what processing methods are used the shape of sides 142 and 144 can be tailored. By way of example only, sides 142 and 144 and bottom 236 can be shaped into a U-groove, a V-groove, sides 142 and 144 can be tilted in toward each other or tilted out away from each other.

Once channel 108 has been formed into substrate 102, if substrate 102 is either made of a conductive material or a semiconductive material, a determination of whether and of what materials will be used and how to process those materials has to be made to form material layer 106. Material layer 106 can be made of any suitable insulative material such as, but not limited to, silicon dioxide or its derivatives, nitride or its derivatives, polymers, or the like. Also, material layer 106 can be formed by any suitable method or technique, such as, but not limited to, coating, deposition, growing, chemical vapor deposition including low pressure chemical vapor deposition; plasma enhanced chemical vapor deposition, or the like.

It should be understood that one reason to form material layer 106 on substrate 102 is to insulate fuel solution 302 and electrolyte solution 304 (as shown in FIG. 3) from substrate 102. However, it should be further understood that there can be other reasons for forming material layer 106 such as, but not limited to, structural advantages, electrical advantages, and the like. Typically, material layer 106 is formed as a substantially uniform layer on substrate 102 and channel 108, thereby electrically isolating channel 108 from substrate 102.

As shown in FIGS. 1, 2, and 3, material layer 106 is a substantially uniform and conform al layer across substrate 102 and throughout channel 108. However, it should be understood that material layer 106 does not need to be conform al. Material layer 106 can be any suitable thickness 230 depending upon the specific design of planar fuel cell 101 and channel 108. Typically, thickness 230 can range from 500 angstroms to 30,000 angstroms, with another thickness ranging from 2,000 angstroms to 20,000 angstroms, with yet another thickness ranging from 5,000 angstroms to 15,000 angstroms.

Generally, with channel 108 being formed in substrate 102, catalytic regions 116 and 118 are formed in end portions 110 and 112 of channel 108. Catalytic regions 116 and 118 can be made of any suitable catalytic material such as, but not limited to, nickel, palladium, platinum, iron, tin, any mixture or combination, or any alloy of same. The ratio of metals in mixtures or alloys can range from 0 to 100%. For example, in nickel/tin mixture tin concentration could be 5% to 25% atomic weight percent of tin in the mixture. Additionally, the catalytic material can be deposited on substrate 102 by any suitable method or technique such as, but not limited to, sputtering, evaporation, and the like. Catalytic regions 116 and 118 can be formed by any suitable method, methods, or combination of methods such as, but not limited to, any additive, subtractive, or combination of additive and/or subtractive, processing technologies well known in the art.

By way of example only, using the additive processing method, a masking layer with openings having the shape and size of catalytic regions 116 and 118 are formed on end portions 112 and 110, respectively. Thus, end portions 112 and 110 are exposed through the openings in the masking layer. Substrate 102 with the masking layer having openings aligning with catalytic regions 116 and 118 are placed into a deposition system, such as a sputtering system, or the like and is processed leaving a layer of material on the masking layer and filling the openings in the masking layer. The sputtering system covers the entire substrate 102 that is facing the sputtering target including the openings and the protected areas covered by the masking layer with a layer of catalytic material. Substrate 102 is subsequently cleaned, thereby removing the catalytic material that was deposited on the masking layer and leaving the material deposited into the openings of the masking layer in place.

By way of example only, using the subtractive processing method, a layer of catalytic material is deposited on surface 104 of substrate 102 having channel 108 previously formed. The catalytic material forms a substantially uniform layer on surface 104 of substrate 102 including channel 108. It should be understood that depending upon the material of substrate 102, catalytic material can be deposited onto material layer 106. A masking layer having the shape and size of catalytic regions 116 and 118 are formed on end portions 112 and 110 of channel 108, while leaving areas surrounding the masking layer exposed. An etch process is performed to remove all exposed areas leaving the areas that were protected by the masking layer in place. Substrate 102 is subsequently cleaned to remove remaining masking layer and leaving the remaining catalytic material in place.

Typically, catalytic regions 116 and 118 have a thickness 232 that can be any suitable thickness. Typically, thickness 232 can range from 500 angstroms to 30,000 angstroms, with another thickness ranging from 100 angstroms 40,000 to angstroms, with yet another thickness ranging from 5,000 angstroms to 15,000 angstroms.

Referring now to FIG. 3, FIG. 3 shows a greatly enlarged simplified isometric sectional illustration of FIG. 2 with a fuel solution 302 and an electrolyte solution 304 present in channel 108 of planar fuel cell 101 having a load 306. Fuel cell chemistry has five (5) basic elements 1) a fuel source (hydrogen or fuel solution 302), 2) an oxygen source indicted by a circle having identifying numeral 308, 3) an anode 138 where the fuel source is oxidized, 4) a cathode 138 where oxygen is reduced, and 5) a mechanism to transport ions here identified as electrolyte solution 304. Generally, fuel solution 302 and electrolyte solution 304 are applied to channel 108 where fuel solution 302 and electrolyte solution 304 are held in place by capillary action. Additionally, since anode 138 and cathode 138 are separated by channel 108 and since fuel solution 302 and electrolyte solutions are liquids, ions can freely migrate, indicated by arrow 314, from anode 138 to cathode 138.

As shown in FIG. 3, fuel solution 302 and electrolyte solution 304 are provided as liquids. Fuel solution 302 can be any suitable source such as, but not limited to, sugar, methanol, alcohol, hydrogen, e.g., elemental or gaseous hydrogen, or the like. Electrolyte solution 304 can be any hydroxyl containing material that can be dissociated in a liquid solution. Electrolytes are not limited to, lithium hydroxide (LiOH), sodium hydroxide (NaOH), potassium hydroxide (KOH), rubidium hydroxide (RbOH), caesium hydroxide (CsOH), and the like. Additionally, it should be understood that electrolyte solution 304 can also be any suitable acidic material that can be dissociated as a liquid solution that can conduct H⁺ ions such as, but not limited to phosphoric acid, sulfuric acid, or the like.

Generally, once fuel cell 108 has been loaded with fuel solution 302 and electrolyte solution 304 and in contact with catalyst material of anode 136 and cathode 138, the chemical reaction, described hereinbelow begins to generate electrical power which can be removed from planar fuel cell 101 though load 306 or other similar device. The electrical power generation is made via a redox reaction between fuel solution 302 and an oxygen source 308. By way of example, with fuel solution 302 being methanol (CH₃OH) and electrolyte solution 304 being potassium hydroxide (lq), methanol is oxidized at anode 136 in accordance with the following reaction:

CH₃OH+6OH⁻→5H₂O+CO₂+6e

producing water (H₂O) and releasing six (6) electrons that flow through conductor 316, load 306, and conductor 318 and into cathode 138, reducing oxygen in the following reaction:

3H₂O+1.50₂+6e→6OH⁻

producing hydroxyl ions (OH⁻) that migrate back to anode 136 through the electrolyte solution 304 that is present in channel 108.

By way of another example, with fuel solution 302 being sugar (C₆H₁₂O₆) and electrolyte solution 304 being potassium hydroxide (KOH), sugar is oxidized at anode 136 in accordance with the following reaction:

C₆H₁₂O₆+2OH⁻→18H₂O+6CO+24e

producing water (H₂O) and releasing twenty-four (24) electrons that flow through conductor 316, load 306, and conductor 318 and into cathode 138, reducing oxygen in the following reaction:

12H₂O+6O₂+24e→24OH⁻

producing hydroxyl ions (OH⁻) that migrate back to anode 136 through the electrolyte solution 304 that is present in channel 108.

Since channel 108, anode 136, and cathode 138 is designed to hold fuel solution 302 and electrolyte solution 304 by capillary action or forces, several problems with the prior art have been solved. Since fuel cross-over is dependant on the unintentional intermixing of the fuel and the oxidant, channel 108 provides for a slow, controlled molecular diffusion though channel 108. Because of the ability to control dimensions such as, but not limited to length 224, depth, 228, planar fuel cell 101 is capable of superior and controlled performance. Similarly, because of the slow molecular diffusion, oxidant diffusing from cathode 138 to anode 136 is slowed down or retarded. As a result, middle portion 114 acts as a barrier and a controlling point to intermixing of fuel and oxidant. And, the properties of electrolytes conduct ions but resist conduction of electrons. Hence, the middle portion serves the function of a membrane, eliminating the need for a discrete Proton Emitting Membrane layer. By having channel 108 separate anode 136 and cathode 138, the plurality of planar fuel cells 100 exemplified by planar fuel cell 101, is achieved and which can be readily manufactured. Moreover, because middle portion 114 of channel 108 takes the place of a PEM material, the PEM material can be eliminated, thereby decreasing cost and increasing manufacturability. Because channel 108 can be physically change and modified, planar fuel cell 101 and channel 108 can be tuned to give better performance. Additionally, replenishing planar fuel cell 101 with fuel solution 302 and/or electrolyte solution 304 is now greatly simplified because anode 138, cathode 138, and channel 108 are relatively open and easy to get too. Replenishing is simply a matter of removing fuel solution 302 and/or electrolyte solution 304 that have been used and refilling with fresh fuel solution 302 and electrolyte solution 304. Moreover, since planar fuel cell 101 is manufactured in a planar manner, planar fuel cell 101 can easily be connected to other fuel cells, exemplified by planar fuel cells 101 and 103 on the same substrate 102, thereby allowing a plurality of individual fuel cells to be connected together and to be able to obtain the desired voltage and current levels.

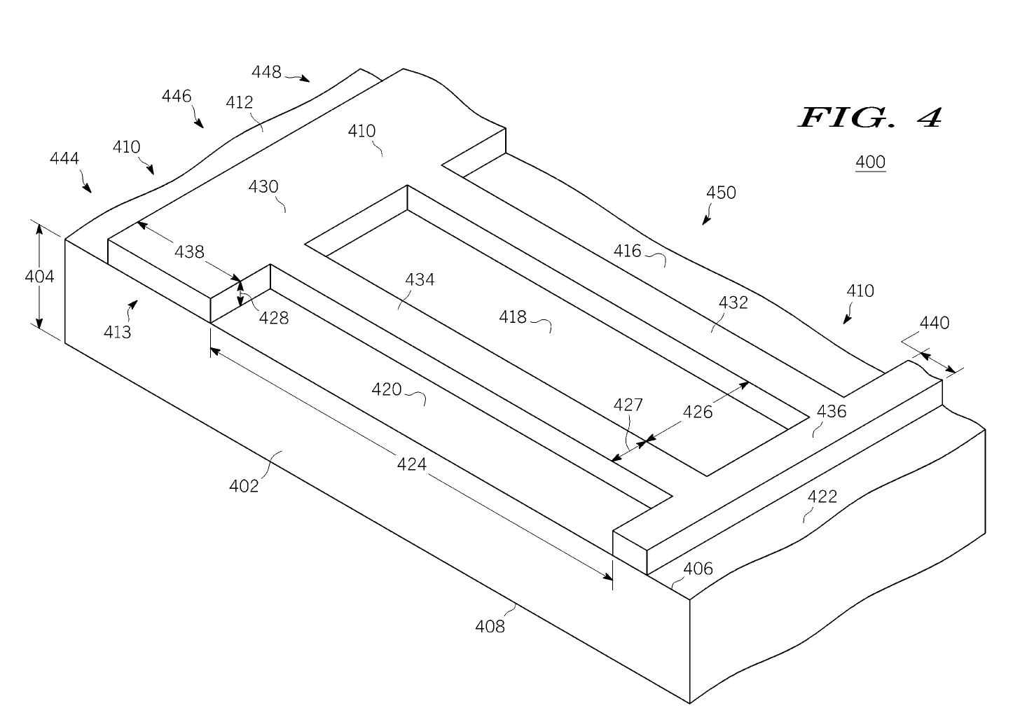

Referring now to FIGS. 4-11, FIGS. 4-11 show isometric sectional illustrations of a series of steps for making a plurality of monolithic fuel cells 400. As shown in FIG. 4, FIG. 4 shows a greatly enlarged simplified isometric sectional illustration of a substrate 402 having a thickness 404, surfaces 406 and 408, wherein surface 406 of the substrate 402 has masking layer 410 that has been formed to make a pattern 450, wherein future monolithic fuel cells 444, 446, and 448 are ready for further processing. It should be understood that substrate 402 can extend side to side and into and out of the Figures.

As previously described with reference to substrate 102 in FIGS. 1-3, substrate 402 can made of any suitable substrate material. Also, as previously described with reference to substrate 102, substrate 402 can be processed by any suitable process or processes that are compatible with the materials used.

As shown in FIG. 4, positive photoresist has been applied to surface 406 of substrate 402, exposed, and developed leaving certain portions, e.g., portion 413, covered by masking layer 410 and certain other exposed portions 412, 416, 418, 420 and 422 have surface 406 exposed. Generally, as can be seen in FIG. 4, exposed portions 416, 418, and 420 are shaped as rectangles having a length 424 and a width 426 with other exposed portions 412 and 422 away from masking layer 410 having surface 406 being exposed.

Generally, photoresist thickness and thickness of masking has been previously described supra. However, it should be understood that thickness 428 of masking layer 410 can vary greatly depending upon substrate 402 types and the processes and materials that are selected to transfer pattern presented in masking layer 410 into substrate 402. Moreover, it should be understood that in some instances a hard mask (not shown) can be utilized when an especially long or corrosive etch chemistry is used to etch substrate 402.

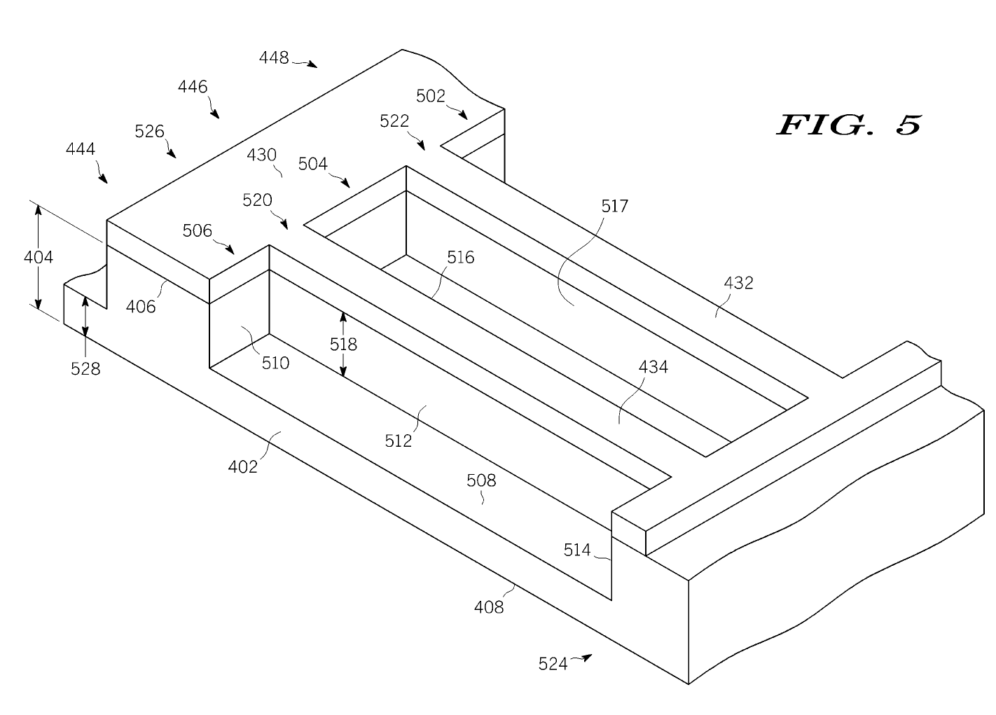

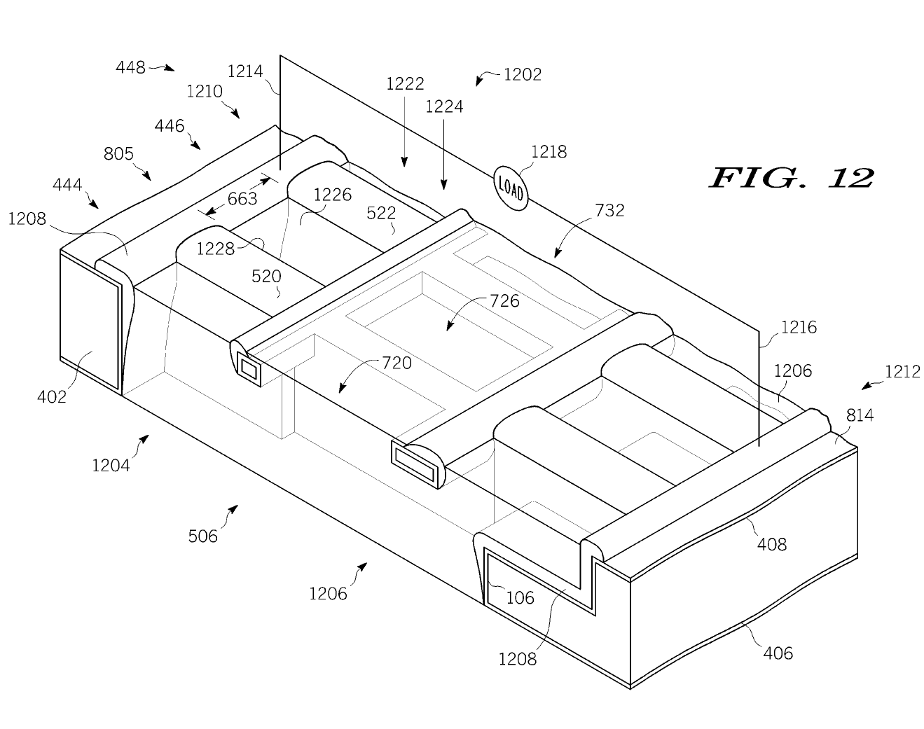

Using future monolithic fuel cell 446 to illustrate, width 426 sets a width that is transferred into substrate 402. Because width 426 partially determines the force of the capillary action between surfaces 516 and 517 that will be formed as shown in FIG. 5. Carefully consideration and calculation needs to be taken in determining width 426. As previously described with reference to depth 228 and width 126 of channel 108 in FIGS. 1-4, a minimum width 426 is calculated using the same equations and premises as previously stated supra so that a sufficient capillary force can be generated to hold fuel solution 1204 and electrolyte solution 1206, as shown in FIG. 12.

Masking layer 410 is made of several areas such as, but not limited to, member 430 having a length 438, members 432 and 434 having lengths 424, widths 426 and 427, and member 436 having length 440. It should be understood that members 430 and 436 can extend into and out of the FIGURE, thereby allowing many more fuel cell to be built then is shown. Generally, members 432 and 434 having lengths 440 and 442, respectively, are shown to be perpendicular to and join members 430 and 436, wherein member 430 has length 438 and member 436 has length 440. However, it should be understood that variations such as, but not limited to, rounding of corners, geometric variation, and the like can be made as long as the capillary forces or action in the fuel cell is sufficient. It should be understood that since monolithic fuel cell 444 is sectioned, monolithic fuel cell 444 a member that would define exposed portion 420 is not shown. Moreover, since exposed portion 416 is broken off, the member that would define exposed portion 416 is not shown.

By way of example, with substrate 402 being made of silicon and with photoresist being made of any suitable photoresist such as, but not limited to Shipley 1350, Kodak 850, or the like. When masking layer 410 has been exposed and developed, substrate 402 is etched to remove portions of exposed portions 412 of substrate 402.

FIG. 5 shows a greatly enlarged simplified isometric sectional illustration of substrate 402 after exposed portions 412, 416, 418, 420, and 422 have been etched. As shown in FIG. 5, pattern 450 of masking layer 410 has been transferred into substrate 402. By etching exposed portions 416, 418, and 420 of substrate 402, cavities 502, 504, and 506 are formed from exposed portions 416, 418, and 420, respectively. Wall 520 separates cavities 506 and 504 and wall 522 separates cavities 504 and 502. Walls 526 and 524 forming ends of cavities 502, 504, 506. Using cavities 504 and 506 to illustrate the various surfaces presented after etching of substrate 402. As can be seen in FIG. 5, cavity 506 includes a surface 508 that forms a bottom of cavity 506, while surfaces 510, 512, 514 of cavity 506, and surface 516 of cavity 504 form sidewalls illustrating inside surfaces of cavities 502, 504, and 506 surfaces.

As shown in FIG. 5, cavities 502, 504, and 506 have been etched to a depth 518. Depth 518 can be any practicable depth and is dependant upon thickness 404 of substrate 402 and width 426 between surfaces 516 and 517 the form sidewalls. By way of example only, with thickness 404 being 700 microns, depth 518 can range from 1 microns to 700 microns;. With the etching or removal of substrate 402 to depth 518 a remaining thickness 528 of substrate 402 is shown.

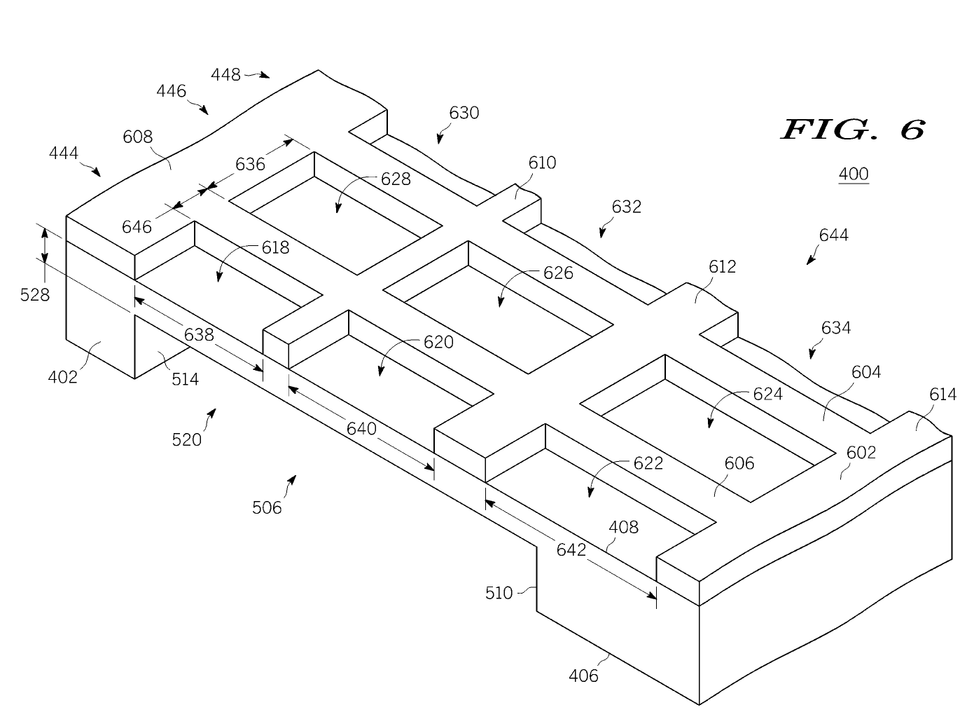

FIG. 6 shows a greatly enlarged simplified isometric sectional illustration of substrate 402, wherein substrate 402 is flipped upside down with surface 408 being on top and another masking layer 602 defining a pattern 644 being disposed on surface 408 of substrate 402. As can be seen from FIGS. 5 and 6, FIG. 6 shows substrate 402 after etch of surface 406 has been completed and substrate 402 has been cleaned; substrate 402 has been flipped over and prepared for a subsequent etch with masking layer 602 disposed on surface 408 of substrate 402. Generally, masking layer 602 has been prepared as previously described to include members 604, 606, 608, 610, 612, and 614, and openings 618, 620, 622, 624, 626, 628, 630, 632, and 634. Members 604 and 606 are approximately the same thickness as walls 520 and 522 and are aligned on top of walls 520 and 522. Member 608 is approximately the same thickness as wall 524 and is aligned on top of wall 524.

Typically, as shown in FIG. 6, the plurality of monolithic fuel cells 400 that are partially fabricated including monolithic fuel cells 444, 446, and 448 identified in masking layer 602 and includes openings 618, 620, and 622; 624, 626; and 628, and 630, 632 and 634, respectively, which exposes surface 408 of substrate 402. Generally, the dimensions of openings 618, 620, and 622; 624, 626; and 628, and 630, 632 and 634 can be described and illustrated with reference to monolithic fuel cell 446. As can be seen in FIG. 6, openings 628, 626, and 624 are fabricated with lengths 638, 640, and 642 with a width 636. Generally, as described previously with reference to channel 108 and width 126, widths 426 and 636 are calculated the same as width 126. However, it should be understood that widths 426 and 636 may be similar or approximately the same, thereby allowing enough tolerance for alignment and robustness of design. Thus, after substrate 402 is finally etched and cleaned cavities 502, 504, and 506 will be continuous with their respective openings. For example cavity 504 will be aligned with openings 628, 626, and 624 and able to induce a strong capillary action, as would be illustrated between surfaces 516 and 517.

Lengths 638, 640, and 642 can be any suitable size depending upon the specific design. In some designs, it can be advantages to make length 642 larger so as to allow a greater surface area though opening 622 after surface 408 has been etched and cleaned

Width 646 can be any suitable size depending upon the specific design. However, in general, width 646 should be about the same as width 427, as shown in FIG. 4, thereby allowing proper alignment of walls 520 and 522.

Etching of substrate 402 has been previously described with reference to the etching of cavities 502, 504, and 506 and need not be described in detail here. However, by way of example only, with substrate 402 being made of a silicon material, etching is typically accomplished by anisotropic etching system using any suitable chemistry such as, but not limited to, a halogen type chemistries including chlorine, fluorine, bromine, like containing chemistries, and any combination of chemistries, or the like.

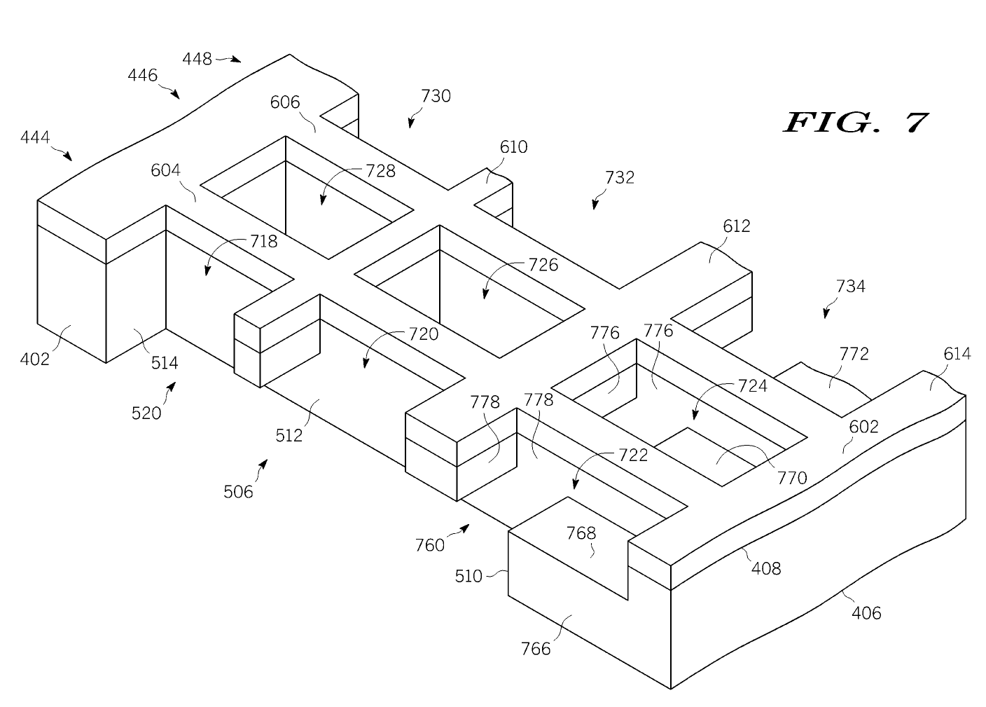

Referring to FIGS. 6 and 7, FIG. 7 shows a greatly enlarged simplified isometric sectional illustration of substrate 402 after surface 408 of substrate 402 that has been etched. As shown in FIG. 7 masking layer 602 is still in place and the pattern of openings 618, 620, 622, 624, 626, 628, 630, 632, and 634 and members 604, 606, 608, 610, 612, and 614, have been transferred into substrate 402 as shown in FIG. 6. Etching of substrate 402 from openings 618, 620, 622, 624, 626, 628, 630, 632, and 634 in masking layer 602 results with openings 718, 720, 722, 724, 726, 728, 730, 732, and 734 in substrate 402 being in direct communication with their respective cavities 502, 504, and 506. Moreover, as shown in FIGS. 6 and 7, etching of openings 622, 624, and 634 results in surfaces 768, 770, and 772 being formed on portion 766 of substrate 402, as well as surfaces 774, 776, 778, 780, and 782. As illustrated by monolithic fuel cell 444 and cavity 506, openings 718, 720, and 722 directly communicate with cavity 506. As shown in FIG. 7, substrate 402 has been etched entirely though opening 622 of masking layer 602 so that opening 722 is in communication with cavity 506 though opening 760 and a portion 766 of substrate 402 remains having a surface 768. Also, as shown in FIG. 7, it should be understood that surface 512 is now complete from openings 718, 720, and 722, as well as surfaces 510 and 514. However, it should be understood that dimensions of openings 718, 720, 722, 724, 726, 728, 730, 732, and 734 can vary irregularly depending upon the desired design.

Generally, cleaning off masking layer 602 can be achieved by any suitable method or technique as discussed previously. It should be understood that cleaning as well as any other process is substrate and materials dependant.

By way of example only, with substrate 402 being made of silicon, any suitable wet clean such as, but not limited to, a solvent, an acid clean, or the like could used. Alternatively, any suitable dry clean such as, but not limited to, gaseous plasma (anisotropic or isotropic), ion milling, or the like can be used.

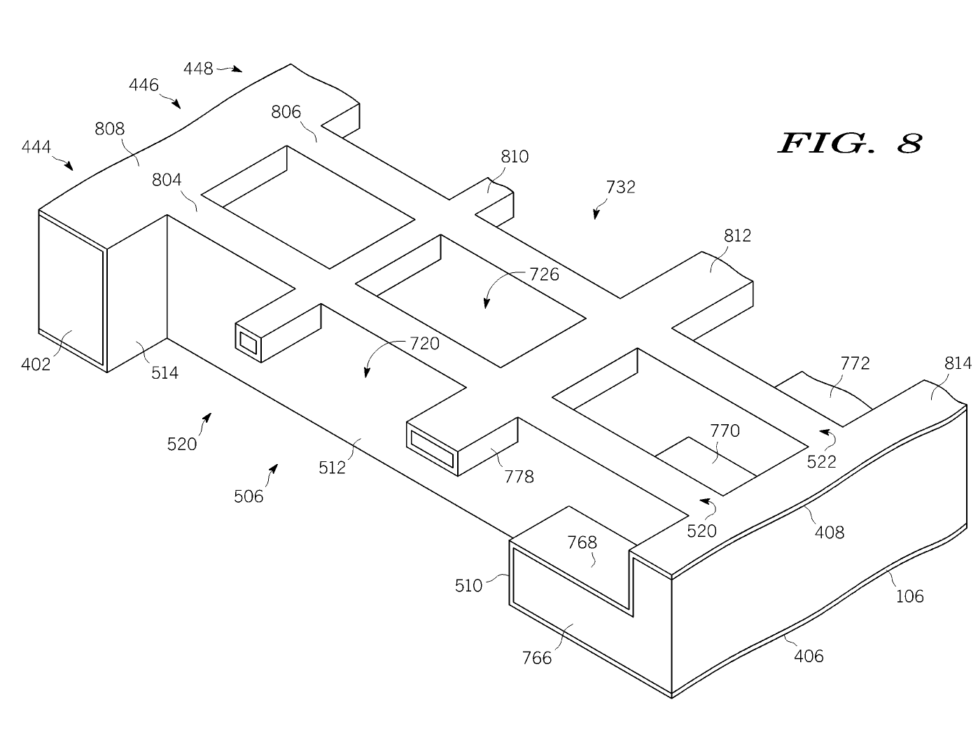

FIG. 8 shows a greatly enlarged simplified isometric sectional illustration of substrate 402 after masking layer 602 (as shown on FIG. 7) on substrate 402 has been removed and cleaned. As shown in FIG. 8, pattern 644 has been transferred to substrate 402 with members 804, 806, 808, 810, 812, and 814 being formed out of substrate 402. It should be understood that surface 516 replicates surface 512, thereby forming monolithic fuel cell 446. Additionally, using monolithic fuel cell 446 to illustrate monolithic fuel cells 444 and 448, walls 520 and 522 separate monolithic fuel cell 446 from monolithic fuel cells 448 and 444, respectively. Also, using monolithic fuel cells 444 and 446 to illustrate for monolithic fuel cells 444, 446, and 448, walls 520 and 522 and surfaces 512, 514, 510, 774, and 778 provides a semi enclosed container that will hold a solution (describe below) by capillary action.

As previously described with reference to material layer 106 in FIGS. 1-3, once substrate 402 is cleaned, an analysis is once again used to determine whether material layer 106 should be used. Depending upon the material nature of substrate 402 and the specific engineering requirements, any suitable dielectric material is selected and deposited by any suitable method or technique. However, as previously described with reference to material layer 106, use of material layer 106 is a choice the needs to be carefully considered.

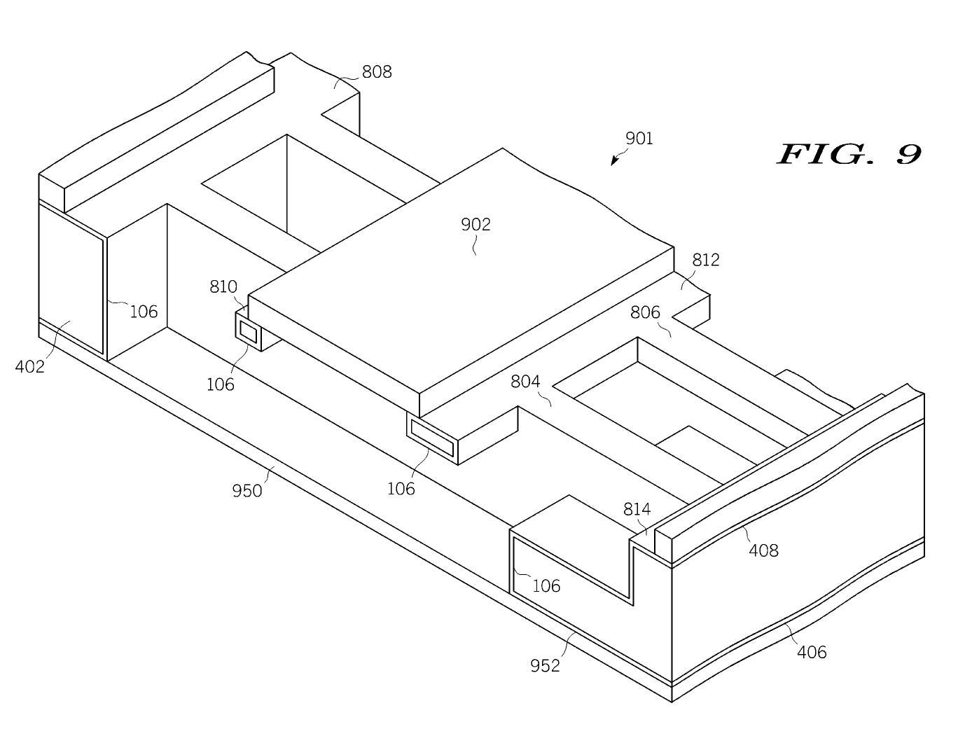

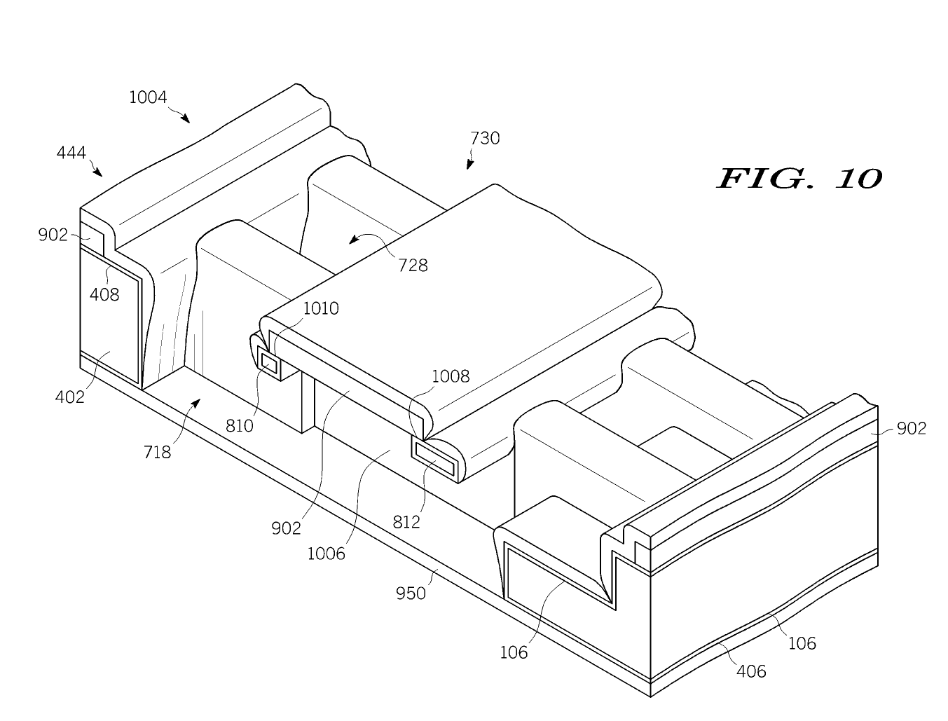

FIG. 9 shows a greatly enlarge simplified isometric sectional illustration showing a masking layer 902 covering openings 720, 726, and 732 in preparation for deposition of a catalytic material as shown in FIG. 10. As shown in FIG. 9, masking layer 902 has been applied, imaged, and developed leaving a pattern 901. As discussed previously, the application, imaging, and developing of a pattern can be achieved by any suitable method or technique.

By way of example only, with substrate 402 being made of silicon, masking layer 902 is made of any suitable photoresist material. Photolithographic processing has been discussed previously and need not be described in detail here. However, briefly, photoresist is applied to surface 406 and subsequently exposed, and developed to form a pattern 901.

It should be understood that in some cases a handle 950 is detachably attached by surface 952 of handle 950 so as to facilitate processing steps of substrate 402. Handle 950 can be made of any suitable material that is compatible with the chemistries and materials used in processing substrate 402.

With masking layer 902 in place, substrate 402 is now ready for deposition of the catalytic material on substrate 402 by any suitable method or technique as previously described supra with reference to FIG. 1-3.

FIG. 10 shows a greatly enlarged simplified isometric sectional illustration of substrate 402, as shown in FIG. 9, after deposition of catalytic material 1004 on substrate 402. As shown in FIG. 10, masking layer 902 has covered and protected openings 720, 726, and 732, shown in FIG. 8, and some surrounding portions from deposition of catalytic material 1004. Using monolithic fuel cell 444 to illustrate it can be seen that, surface 1006 under masking layer 902 and portions 1008 and 1010 of members 810 and 812 are free of catalytic material. Whereas exposed areas (as shown in FIG. 9) e.g., portions of members 808, 810, 812, 814, 804, and 806 are covered with catalytic material 1004.

Various catalytic materials and combinations of the various catalytic materials and the methods and techniques for depositing same that are used for catalytic material 1004 and have been previously described and need not be describe in detail here. However, it should be understood that in some instances, different catalytic materials can be deposited in different places on substrate 402. For example only, if it was desired to deposit catalyst-a on surrounding portions, of openings 718, 728, and 730, the above described process could be used, but masking layer 902 would cover openings 720, 726, 732, 722, 724, and 734 and surrounding portions, thereby protecting openings 720, 726, 732, 722, 724, and 734 and the surrounding portions from having catalytic material 1004 from being deposited. It should be understood that the above described process can be modified to protect and cover any desired location on substrate 402.

By way of example only, with substrate 402 being made of silicon and with masking layer being made of photoresist, catalytic material 1004 is deposited onto masking layer 902 and surface 408 not covered by masking layer 902. Catalytic materials 1004 and the application of the catalytic materials have been discussed previously and need not be discussed in any great detail. However, it should be understood that any suitable catalytic material, catalytic materials, or combination thereof deposited by any suitable methods or techniques that are compatible with the material system(s) can be used.

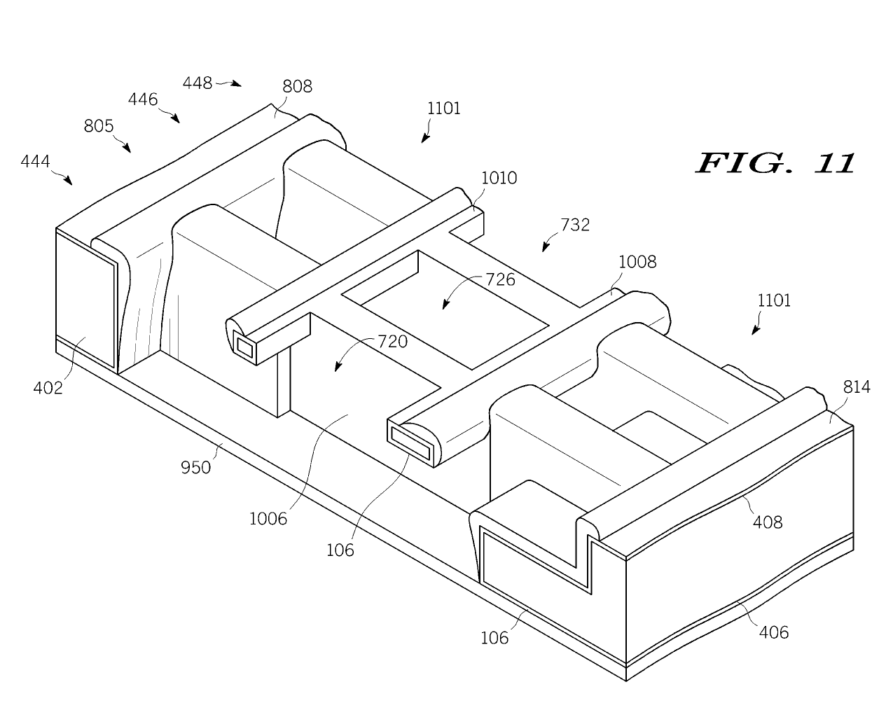

FIG. 11 shows a greatly enlarged simplified isometric sectional illustration of substrate 402 with photoresist masking layer 902 and catalytic material that was disposed on masking layer 902, as shown in FIG. 10, have been removed, while areas 1101 of surface 408 illustrate areas where catalytic material was not protected by masking material 902 and where catalytic material is deposited on substrate 402 and have not been removed. Additionally, as can be seen in FIG. 10, areas that where shaded or protected from deposition of catalytic material, e.g., surface 1006, are free of catalytic material. Removal of masking layer 902 and excess catalytic material leaves openings 720, 726, and 732 and surrounding portions 1008 and 1010, surface 1006, and portions of members 814 and 808 clean and without catalytic material, while other portions are covered by catalytic material.

Removal of photoresist masking layer 902 and excess catalytic material can be achieved by any suitable method or technique that is compatible with the present material system. Generally, the process described above is known as a lift-off process. Essentially, the unwanted material, i.e., masking layer 902 and unwanted catalytic material that was covering the masking layer 902 is washed away, leaving the wanted catalytic material 1102 on the portions that were not covered by masking layer 902. However, it should be understood that any additive or substantive process can be used for so that catalytic material is deposited in the correct locations.

By way of example, with substrate 402 being made of silicon, masking layer 902 can be removed with a solvent base resist removal system such as, but not limited to, alcohol, acetone, R-10, any suitable combination, or the like. However, it should be understood that any suitable method that is capable of patterning substrate 402 with catalytic material in the appropriate positions can be used.

FIG. 12 shows a greatly enlarged simplified isometric sectional illustration of a plurality of completed monolithic fuel cells 1202 having fuel solution 1204 and electrolyte solution 1206 installed. Using completed monolithic fuel cell 444 to illustrate completed monolithic fuel cells 446 and 448, fuel solution 1204 and electrolyte solution 1206 are suspended in channel or cavity 506 by capillary action. The capillary action is caused by the placing walls 520 and 522, and their respective surfaces, illustrated by surfaces 1226 and 1228, at a certain minimum width 636, thus enabling fuel solution 1204 and electrolyte solution 1206 to be held in place by capillary action. It should be also noted that fuel solution 1204 and electrolyte solution 1206 are in contact with catalytic material 1208 of an anode 1210 and a cathode 1212, thereby allowing electrical power to be extracted from the plurality of monolithic fuel cells 1202 by electrical connections 1214 and 1216.

The chemistry of this particular fuel cell has been described supra and need not be described in detail here. However, several things should be pointed out for a clearer understanding of how the plurality of monolithic fuel cells 1202 functions. Using monolithic fuel cell 444 to illustrate, since cavity 506, anode 1210, and cathode 1212 have been designed to hold fuel solution 1204 and electrolyte solution 1206 by capillary action or forces several problems with the prior art have been solved or eliminated. First, by having channels or cavities 502, 504, and 506 separate anode 1210 and cathode 1212, molecular diffusion in the fuel solution 1204 and electrolyte solution 1206 slows down and retards a cross over effect of fuel from anode 1210 to cathode 1212 as well as a cross over effect of oxidant from cathode 1212 to anode 1210, thereby improving performance. The barrier to cross over of fuel and oxidant created in this way serves the purpose of a membrane since the in electrolyte material conducts ions, but does not conduct electrons. Hence, a monolithic fuel cell 444 and the plurality of monolithic fuel cells is achievable that can be readily manufactured at an inexpensive cost and having greater reliability and flexibility. Moreover, since cavity 502 takes the place of PEM material, the PEM is eliminated, thereby decreasing cost and increasing manufacturability. Because cavities 502, 504, and 506 and other physical parameters are now easily manipulated and engineered, the monolithic fuel cell 444 and the plurality of monolithic fuel cells 1202 can now be tuned for greater performance. Additionally, re-fueling of monolithic fuel cell 444, for example, and the plurality of monolithic fuel cells 1202 is now capable of being achieved without disassembly, thereby saving time, effort, and bringing practical flexibility.

Moreover, use of this design as shown in FIGS. 4-12 allows for both a static and a dynamic fuel cell. Static fuel cells have fuel solution 1204 and the electrolyte solution 1206 in a non-moving system where diffusion of ions from anode 1210 to cathode 1212 is though non-moving fuel solution 1204 and electrolyte solution 1206. When fuel solution 1204 and electrolyte solution 1206 is exhausted, the exhausted fuel solution 1204 and electrolyte solution 1206 is removed and replenished. However, as shown in FIG. 12, replenishment of fuel solution 1204 and electrolyte solution 1206 can be dynamically controlled by a fuel solution input 1222 and electrolyte solution input 1224. Thus, fuel solution 1204 and electrolyte solution 1206 can be dynamically added, controlled, and removed at any desired time and therefore fuel cell can be tuned for maximum performance of any desired level, e.g., voltage, current, power, or the like.

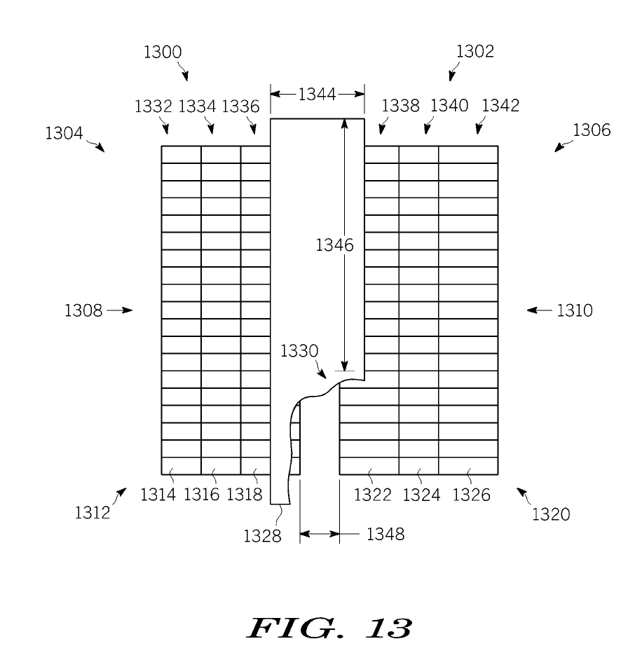

FIG. 13 is a greatly enlarged schematic topographic plan illustration of a fuel cell power system 1300 suitable for use with planar fuel cell(s) 101, a plurality of monolithic fuels cells 400, and the like disposed on a substrate 1302. Fuel cell power system 1300 includes several main elements including arrays 1304 and 1306, pluralities of fuel cells 1308 and 1310 with individual fuel cells exemplified by monolithic fuel cells 1312 and 1320 having anodes 1314 and 1322, channels 1316 and 1324, and cathodes 1318 and 1326, respectively, and wherein anodes along column 1332 form a common anode, wherein cathodes along column 1336 form a common cathode 1318 for array for array 1304, and wherein anodes, along 1338 along column 1338 form a common anode, and wherein cathodes along column 1342 form a common cathode, and bipolar plate 1328 with a portion 1330 broken away to reveal some inner structures under bipolar plate 1328.

Fabrication, processing, and materials used for making planar fuel cell 101 and the plurality of monolithic fuel cells 400 have described hereinabove and need not be described in any great detail here. However, it should be understood that some of the processing techniques used to make substrate 1302 can be similar to the processes used to fabricate planar fuel cell 101 and the plurality of monolithic fuel cells 400, but on a slightly different scale.

As shown in FIG. 13 and by way of example, the pluralities of monolithic fuel cells 1308 and 1310 are made of individual monolithic fuel cells, e.g., monolithic fuel cell 1312 and 1320 which includes anodes 1314 and 1322, channels 1316 and 1324, and cathodes 1318 and 1326, respectively. The individual monolithic fuel cells, e.g. monolithic fuel cell 1312 and monolithic fuel cell 1320, are arranged on substrate 1302 in close proximity to each other to form arrays 1308 and 1310 of any desirable orientation and configuration. By way of example only, FIG. 13 illustrates that individual monolithic fuel cells 1312 and 1320 can be configured in ordered arrays 1308 and 1310, wherein anodes such as anode 1314 are aligned, wherein channels such as channel 1316 are aligned, and wherein cathodes such as cathodes 1318 are aligned in columns 1332, 1334, and 1336, respectively; like wise, anodes such as anode 1322, channels such as channel 1324, and cathodes such as cathode 1326 are aligned in columns 1338, 1340, and 1342, respectively. With arrays 1308 and 1310 configured in this manner, arrays 1308 and 1310 are electrically coupled by bipolar plate 1328 wherein anodes found in column 1336 are coupled to cathodes found in column 1338.

Bipolar plate 1328 can be made of any suitable conductive material and processed by any suitable method or technique as previously described hereinabove. As shown in FIG. 13 shows bipolar plate 1328 is patterned so that a width 1344 of bipolar plate 1328 extends across and a length 1346 down column s 1336 and 1338 to electrically couple arrays 1304 and 1306 together. It should be understood that multiple fuel cells can be couple in series by bipolar plates, thereby selecting a desired voltage. Width 1344 and length 1346 can be any suitable desirable width and length. Generally, width 1344 can be any suitable range, wherein electrical contact is made between cathode 1318 to anode 1322 to not wider then the design tolerances that would electrically change channels 1316 and 1324. However it should be understood that by changing length 1346 of bipolar plate 1328 can change the number of the plurality of fuel cells 1308 and 1310 electrically coupled, thereby changing electrical output characteristics of monolithic fuel cell power system 1300. By way of example only, since bipolar plate 1328 has coupled arrays 1308 and 1310 in series, changing length 1346 changes a current output of arrays 1308 and 1310, thereby enabling output current selection by changing length 1346 of bipolar plate 1328 during manufacture. It should be further understood that by configuring arrays 1308 and 1310 and by positioning bipolar plate 1328, a current output can be manipulated of monolithic fuel cell power system 1300 can be selected in manufacturing.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

We claim:

1. A planar fuel cell comprising:
a substrate having a substantially planar surface;
a channel disposed into the substrate, the channel having a length, a width, a depth, a first end portion, a second end portion, and a middle portion, a second surface and a third surface, the second surface and the third surface spaced apart with a minimum distance to generate a capillary force between the first surface and the second surface, the first end portion and the second end portion spaced apart and coupled through the middle portion of the channel; and
a first catalytic region and a second catalytic region, the first catalytic region disposed onto at least a portion of the first end portion of the channel and the second catalytic portion disposed onto a portion of the second end portion of the channel, with the first catalytic region and the second catalytic region are spaced apart.

2. The planar fuel cell as claimed in claim 1 wherein the substrate is a dielectric material.

3. The planar fuel cell as claimed in claim 2 wherein the dielectric material is a polymer material.

4. The planar fuel cell as claim in claim 2 wherein the dielectric material is ceramic material.

5. The planar fuel cell as claimed in claim 2 wherein the width of the channel ranges from 3 microns to 70000 microns.

6. The planar fuel cell as claimed 2 wherein the depth of the channel ranges from 3 microns to 70000 microns.

7. The planar fuel cell as claimed 2 wherein the first catalytic portion is made from a transition metal material, noble metal material, or perovskite material.

8. The planar fuel cell as claimed in claim 7 wherein the first catalytic region is made of a mixture of metal materials.

9. The planar fuel cell as claimed in claim 8 wherein the first catalytic region is made of portions of nickel/tin.

10. The planar fuel cell as claimed in claim 8 wherein the first catalytic region is made of portions of platinum/rubidium.

11. The planar fuel cell as claimed in claim 1 wherein the substrate is made of a semiconductor material.

12. The planar fuel cell as claimed in claim 11 wherein the channel is lined by dielectric material.

13. The planar fuel cell as claimed in claim 12 wherein the dielectric material is made of silicon dioxide material.

14. The planar fuel cell as claimed in claim 12 wherein the dielectric material is made or a silicon nitride material.

15. The planar fuel cell as claimed in claim 11 wherein the width of the channel ranges from 3 microns to 70000 microns.

16. The planar fuel cell as claim in claim 11 wherein the depth of the channel ranges from 3 microns to 70000 microns.

17. The planar fuel cell as claimed 2 wherein the second catalytic region is made from a transition metal material, noble metal material, or perovkite material.

18. The planar fuel cell as claimed in claim 17 wherein the second catalytic region is made of a mixture of metal materials.

19. The planar fuel cell as claimed in claim 17, wherein the second catalytic region is made of portions of nickel/tin.

20. The planar fuel cell as claimed in claim 17, wherein the second catalytic region is made of portions of platinum/rubidium.

21. The planar fuel cell as claimed in claim 1, wherein the planar fuel cell is a plurality of fuel cells.

22. A method of making a planar fuel cell comprising the steps of:
providing a substrate with a surface;
forming a channel having a length a width, a depth, a first end portion and a second end portion, and a middle portion, a second surface and a third surface, into the surface of the substrate, the second surface and the third surface space a part with a minimum width to generate a capillary force between the second surface and the third surface, the first end portion and the second end portion being spaced apart and coupled by the middle portion of the channel;
forming a first catalytic region on at least a portion of the first end portion of the channel; and
forming a second catalytic region on at least a portion of the second end portion of the channel.

23. The method of making a planar fuel cell as claimed in claim 22, wherein the step of forming the channel, the channel is formed by a photolithographic process.

24. The method of making a planar fuel cell as claimed in claim 22, wherein the step of forming the channel, the channel is formed by a stamping process.

25. The method of making a planar fuel cell as claimed in claim 22, wherein the step of forming a first catalytic region, the catalytic region is formed by a photolithographic process.

26. A monolithic fuel cell device comprising:
a substrate having a first surface and a second surface;
a first opening, a second opening, and a third opening disposed into the first surface of the substrate, wherein the second opening is disposed between the first opening and the second opening;
a cavity having a first wall and a second wall, the cavity extending under a portion of the first opening, a portion of the second opening, and a portion of the third opening, wherein the cavity communicates with the first opening, the second opening, and the third opening and wherein the first wall and the second wall are positioned and spaced a part with a width to support a capillary force;
a first catalytic region disposed onto at least a portion of the first opening and onto at least a first portion of the first surface of the substrate and spaced apart from the second opening and the third opening; and
a second catalytic region disposed onto at least a portion of the third opening and onto at least a second portion of the first surface of the substrate spaced apart from the first portion of the first surface and spaced apart from the first opening and spaced apart from the second opening.

27. The monolithic fuel cell device as claimed in claim 26, wherein the substrate is made from a dielectric material.

28. The monolithic fuel cell device as claimed in claim 27, wherein the dielectric material is a polymer material.

29. The monolithic fuel cell device as claimed in claim 26, wherein the substrate material is made of a semiconductor material.

30. The monolithic fuel cell device as claimed in claim 29, wherein the cavity is lined by a dielectric material.

31. The monolithic fuel cell device as claimed in claim 30 wherein the dielectric material is a nitride material.

32. The monolithic fuel cell device as claimed in claim 30 wherein the dielectric material is a oxide material.

33. The monolithic fuel cell device as claimed in claim 26, wherein the width between the first wall and the second wall ranges from 3 microns to 70000 microns.

34. The monolithic fuel cell device as claimed in claim 26, wherein the first catalytic region is made of a metal material.

35. The monolithic fuel cell device as claimed in claim 30, wherein the first catalytic region is made of a mixture of metal materials.

36. The monolithic fuel cell device as claimed in claim 26, wherein the monolithic fuel cell is a plurality of monolithic fuel cells.

37. A method for making a monolithic fuel cell device comprising:
providing substrate having a first surface and a second surface;
forming a first opening, a second opening, and a third opening disposed into the first surface of the substrate;
forming a cavity extending under a portion of the first opening, a portion of the second opening, and a portion of the third opening, where the cavity communicates with the first opening, the second opening, and the third opening;
forming first catalytic region disposed onto at least a portion of the first opening and onto at least a first portion of the first surface of the substrate and spaced apart from the second opening and the third opening; and
forming second catalytic region disposed onto at least a portion of the third opening and onto at least a second portion of the first surface of the substrate spaced apart from the first portion of the first surface and spaced apart from the first opening and spaced apart from the second opening.

38. The method for making a monolithic fuel cell as claimed in claim 37, wherein the step of forming a cavity, the cavity is formed by patterning using photolithographic and etching process.

39. The method for making a monolithic fuel cell as claimed in claim 37, wherein the step of forming a first catalytic region is achieved by a lift-off process.

40. The method for making a monolithic fuel cell as claimed in claim 36 wherein the step of forming a first catalytic region is achieved by a photographic and etching process.

41. A fuel cell power system using a fuel cell bipolar plate comprising:
a substrate having a first surface;
a first plurality of monolithic fuels cells having a first common anode and a first common cathode disposed on the first surface of the substrate;
a second plurality of monolithic fuel cells having a second common anode and a second common cathode disposed onto the first surface of the substrate; and
a bipolar plate disposed on the first common anode and on the first common cathode that electrically and physically couples the first common cathode of the first plurality of monolithic fuel cells to the second common anode of the second plurality of monolithic fuel cells.

42. The fuel cell power system using a fuel cell bipolar plate as claimed in claim 41 wherein, the bipolar plate simultaneously covers the first common anode and the first common cathode.
